(19) United States
(12) Patent Application Publication
(10) Pub. No.: US 2015/0082537 A1
(43) Pub. Date: Mar. 26, 2015

(54) WHEELCHAIR AND BED TO BE COMBINED WITH THE SAME

(71) Applicant: PANASONIC INTELLECTUAL PROPERTY MANAGEMENT CO., LTD., Osaka (JP)

(72) Inventors: Akihiro Ohta, Osaka (JP); Shohei Tsukada, Hyogo (JP); Mizuho Sakakibara, Tokyo (JP); Yohei Kume, Osaka (JP); Tomohiro Shimoda, Tokyo (JP); Hideo Kawakami, Osaka (JP)

(21) Appl. No.: 14/389,231

(22) PCT Filed: Dec. 12, 2013
(86) PCT No.: PCT/JP2013/007313

§ 371 Date: Sep. 29, 2014

(30) Foreign Application Priority Data
Dec. 13, 2012 (JP) 2012-271953

(51) Int. Cl. A61G 5/00; A61G 5/12

(52) U.S. Cl. CPC A61G 5/006; A61G 5/12; A61G 2005/125
USPC 5/2.1; 297/411.35

(57) ABSTRACT

A wheelchair includes a first seat portion and a second armrest rotatably fixed to a first support portion of the first seat portion, a first rotation axis of this second armrest is arranged on an imaginary plane perpendicular to a back bottom support surface and parallel to the front and rear direction of the first seat portion so as to make a predetermined angle with respect to the back bottom support surface.

### TECHNICAL FIELD

The present invention relates to a wheelchair having an armrest capable of being deployed and retreated, and a bed to be combined with the same.

### BACKGROUND ART

In nursing care to a care-receiver such as an aged person or an ailing person (hereinafter, referred to as the care-receiver), a wheelchair is used. As a wheelchair, a manually operated type wheelchair to be manually pushed by a care-giver from a back surface thereof to travel, or an electrically driven type wheelchair to be self-propelled by an operation of the care-receiver himself/herself is used. These wheelchairs include armrests for stably supporting an arm or the like. For the care-receiver to get on and off in the side surface direction of the wheelchair, a wheelchair that has a rotatable armrest is proposed (for example, refer to Patent Literature 1).

FIG. 8 is a schematic view showing a conventional wheelchair of Patent Literature 1.

In FIG. 8, a wheelchair 10 includes a carriage portion 11 that travels with wheels 11a, a seat portion 12 that changes a seating posture of a passenger (care-receiver) 14 by a posture change, and an armrest 13 rotatably supported by a back bottom support surface 12a that supports a back of the passenger 14.

By rotating the armrest 13 about a rotation shaft 15, the armrest 13 can be retreated on the side of the back bottom support surface 12a from a deployed state of the armrest 13 shown in FIG. 8. The rotation shaft 15 is a shaft parallel to the back bottom support surface 12a, the shaft extending in the side surface direction of the wheelchair 10.

### CITATION LIST

### Patent Literature

Patent Literature 1: JP 2004-275486 A

### SUMMARY OF INVENTION

### Technical Problem

However, with the configuration of the conventional wheelchair 10, there is a need for making an elbow and a shoulder of the passenger 14 avoid a rotation action of the armrest 13 in such a manner that the elbow and the shoulder of the passenger 14 are not brought into contact with the armrest 13 at the time of retreating and at the time of deploying the armrest 13.

The present invention is to solve such a problem, and an object thereof is to provide a wheelchair and a bed to be combined with the same, with each of which there is no need for making an elbow and a shoulder of a passenger avoid at the time of retreating and at the time of deploying.

### Solution to Problem

In order to accomplish the object of the present invention, there is provided a wheelchair comprising:

a first seat portion that at least has a first support portion having a back bottom support surface on a surface;

first and second armrests; and

a third drive unit that forward and backward rotates the second armrest about a first rotation axis, to move the second armrest between a deployed position and a retreated position placed behind the first support portion,

wherein the first rotation axis is arranged on a plane perpendicular to the back bottom support surface of the first seat portion and parallel to a front and rear direction of the first seat portion.

In order to accomplish the object of the present invention, there is provided a bed comprising:

the wheelchair according to the above aspect; and

a bed base portion to be combined with the wheelchair to form the bed.

### Advantageous Effects of Invention

According to the present invention, the wheelchair and the bed to be combined with the same, with each of which there is no need for making the elbow and the shoulder of the passenger avoid at the time of retreating and at the time of deploying can be provided.

### BRIEF DESCRIPTION OF DRAWINGS

These and other objects and features of the present invention will become clear from the following description taken in conjunction with the embodiments thereof with reference to the accompanying drawings, in which:

FIG. 1 is a schematic view showing an action of an armrest in a first embodiment of the present invention;

FIG. 2 is a plan view showing the action of the armrest in the first embodiment;

FIG. 3A is a perspective view showing a wheelchair in a state where the armrest in the first embodiment is deployed;

FIG. 3B is a perspective view showing the wheelchair in a state where the armrest in the first embodiment is retreated;

FIG. 3C is an illustrative view schematically showing a rotation action of the armrest and an armrest support portion in the first embodiment;

FIG. 4A is a schematic sectional view showing an armrest structure on an imaginary plane of the wheelchair in the first embodiment;

FIG. 4B is an illustrative view for illustrating a length of the armrest support portion of the wheelchair in the first embodiment;

FIG. 5 is a flowchart of combination actions of the wheelchair in the first embodiment;

FIG. 6A is a perspective view of the wheelchair and a bed base portion in a state where a posture change step in the first embodiment is completed;

FIG. 6B is a perspective view of the wheelchair and the bed base portion in a state where an adjacent step in the first embodiment is completed;

FIG. 6C is a flowchart of an action procedure for automatically performing an armrest retreating step of the wheelchair in the first embodiment;

FIG. 6D is a block diagram of a control system of the wheelchair in the first embodiment;

FIG. 7A is a perspective view of the wheelchair and the bed base portion in a state where the armrest retreating step in the first embodiment is completed;

FIG. 7B is a perspective view of the wheelchair and the bed base portion in a state where a bed deformation step in the first embodiment is completed; and

FIG. 8 is a schematic view showing a conventional wheelchair.

### DESCRIPTION OF EMBODIMENTS

Hereinafter, embodiments of the present invention will be described with reference to the drawings. It should be noted that the same constituent elements will be given the same reference signs, and description thereof will sometimes be omitted. For easy understanding, the drawings are schematic focusing on the constituent elements.

### First Embodiment

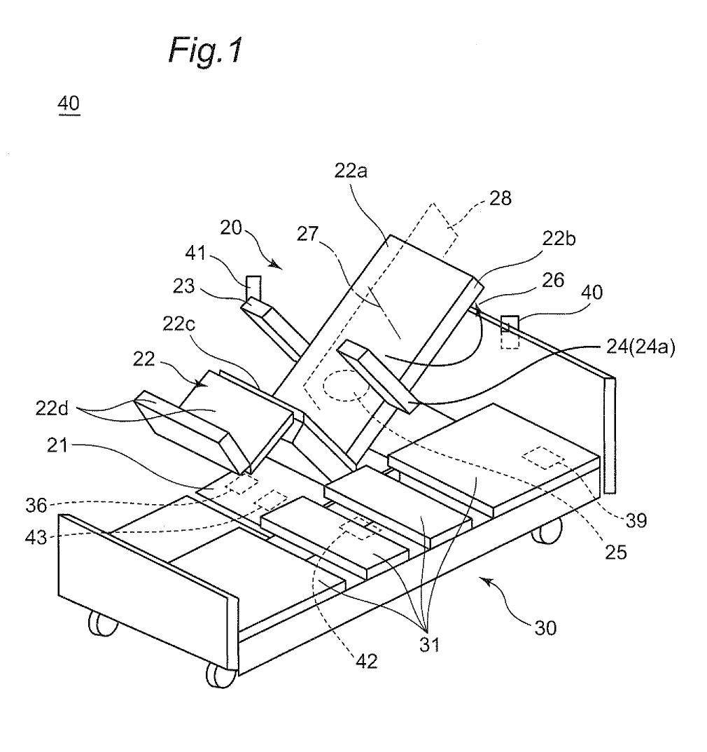

FIG. 1 is a schematic view showing an action of an armrest in a first embodiment of the present invention.

As shown in FIG. 1, a bed 40 of the first embodiment includes a wheelchair 20, and a bed base portion 30. The bed 40 of the first embodiment is formed by combining the wheelchair 20 with the bed base portion 30.

The bed base portion 30 includes first seat portions 31, a first operating unit 44, a first drive unit 42, and a first control unit 39. The first seat portions 31 are one example of a bed seat portion. The first operating unit 44 is one example of a bed operating unit. The first drive unit 42 is one example of a bed drive unit. The first drive unit 42 lifts the first seat portions by an operation of the first operating unit 44. It should be noted that in a state of the bed 40 where the wheelchair 20 and the bed base portion 30 are combined with each other, by the operation of the first operating unit 44, the first seat portions 31 and a second seat portion 22 to be described later are integrated with each other and a posture change is performed by the first drive unit 42.

The wheelchair 20 includes a carriage portion 21, the second seat portion 22, a first armrest 23, a second armrest 24, a second operating unit 41, a third drive unit 25, and a second control unit 36. The second seat portion 22 is one example of a wheelchair seat portion. The second operating unit 41 is one example of a wheelchair operating unit. The third drive unit 25 is one example of an armrest drive unit.

The carriage portion 21 travels with wheels (not shown) and supports the second seat portion 22 thereon. In a case where the wheelchair 20 is used as an electrically driven wheelchair, a second drive unit 43 serving as one example of a wheelchair drive unit is provided, and the wheels of the carriage portion 21 are driven by the second drive unit 43 by an operation of the second operating unit 41.

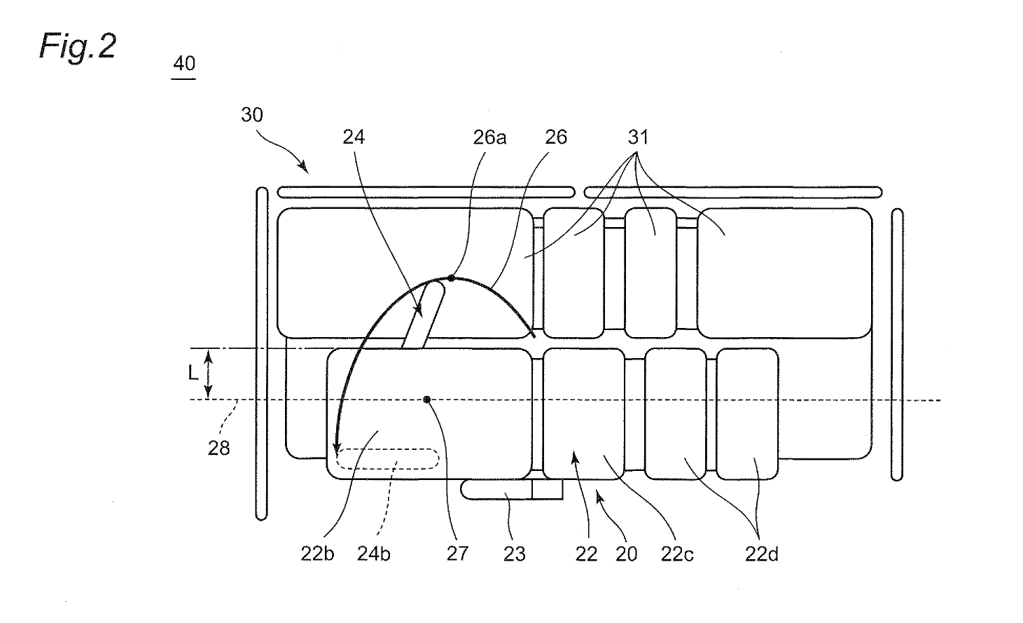

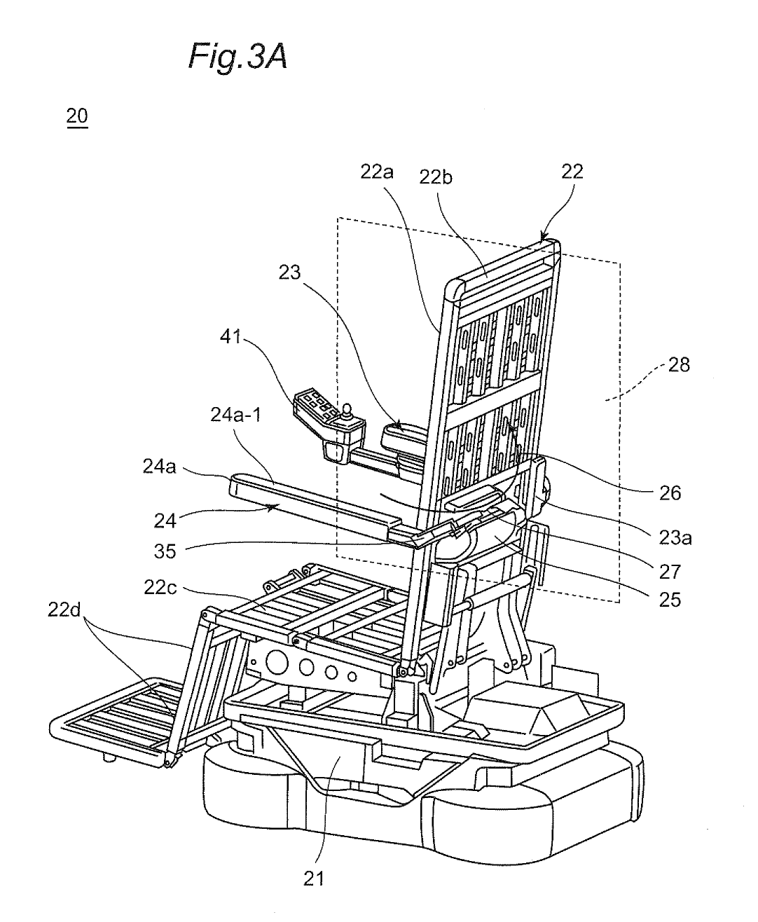

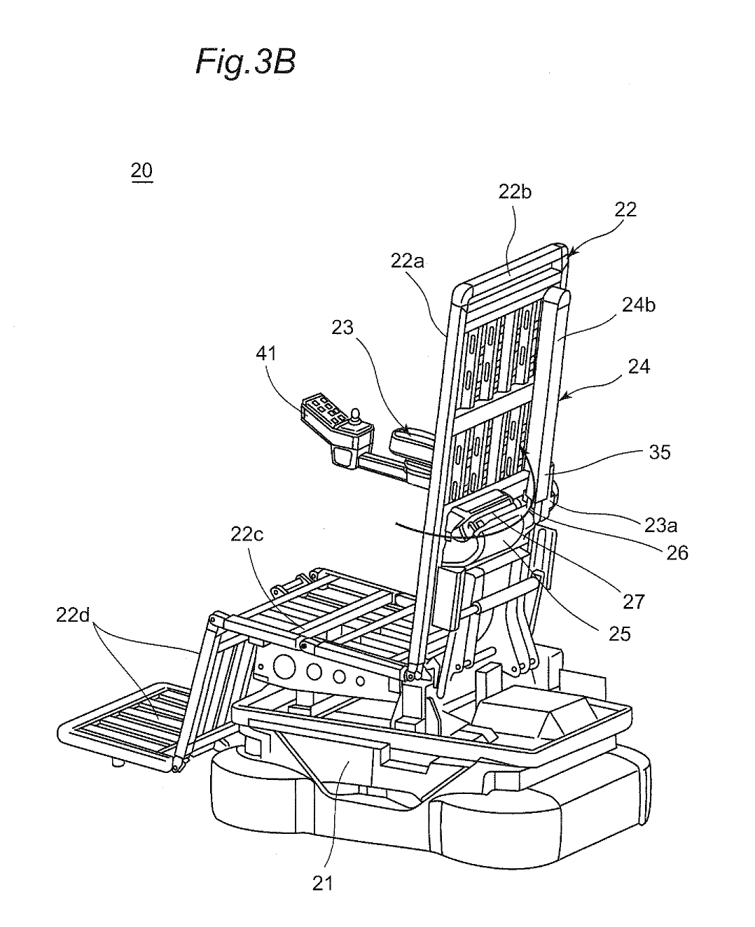

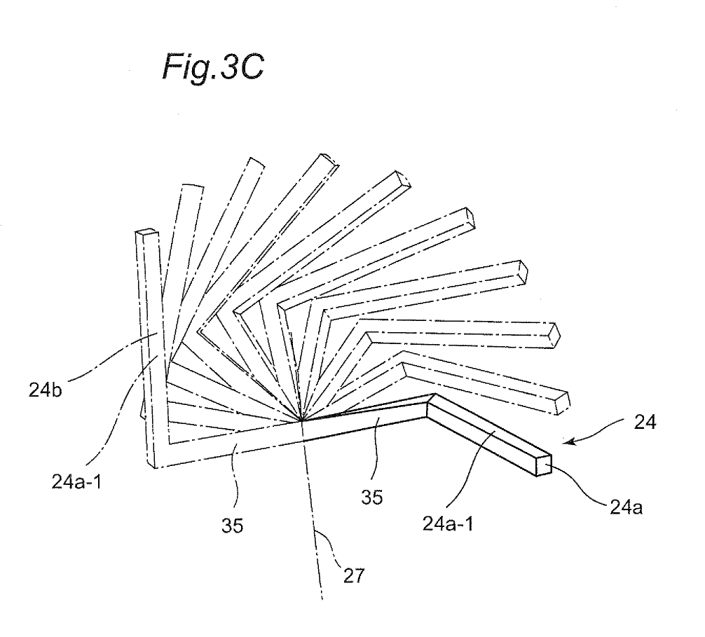

The second seat portion 22 is a part on which a passenger is seated or leans (rests). The second seat portion 22 at least has a first support portion 22b having a back bottom support surface 22a on a surface, is supported by the carriage portion 21, and changes a seating posture of the passenger by a posture change. The first support portion 22b is one example of a back bottom support portion of the wheelchair 20. The back bottom support surface 22a is a surface capable of supporting a back of the passenger as shown in FIGS. 1 and 2 and the like. However, FIG. 3A and the like show the second seat portion 22 including the first support portion 22b or the like as a bottom member from which a cushion member such as a mat or the like attached to the surface side is removed. In these cases, for example, an imaginary plane on the surface side of the first support portion 22b serves as the back bottom support surface 22a. The second seat portion 22 has a second support portion 22c on which buttocks of the passenger are mounted, third support portions 22d capable of supporting legs of the passenger, and the like, in addition to the first support portion 22b. The second support portion 22c is one example of a seating portion of the wheelchair 20. The third support portions 22d are one example of a leg support portion of the wheelchair 20.

The first armrest 23 is an armrest placed in one side part (right side part in FIG. 1 and the like) of the first support portion 22b, and placed in the side part on the opposite side of the bed base portion 30 at the time of combination with the bed base portion 30. The first armrest 23 is rotatably supported by the first support portion 22b on a plane in the up and down direction.

The second armrest 24 is an armrest placed in the other side part (left side part in FIG. 1 or the like) of the first support portion 22b, and placed in the side part on the side of the bed base portion 30 at the time of combination with the bed base portion 30. The second armrest 24 is rotatably supported by the first support portion 22b. It should be noted that the second armrest 24 shown in FIG. 1 is placed at a deployed position (protruding position) 24a at the time of deployment. The second armrest 24 shown by a broken line in FIG. 2 is placed at a retreated position 24b at the time of retreating. The third drive unit 25 connected to a base end of the second armrest 24 is arranged on the back surface side of the first support portion 22b. The third drive unit 25 is one example of an armrest drive unit. The second armrest 24 is connected to the third drive unit 25 at one end of an L shape member (L shape portion 35) serving as a part thereof. Therefore, the second armrest 24 is rotated by about 180° and moved between the deployed position 24a in the side part of the first support portion 22b and the retreated position 24b on the back surface side of the first support portion 22b, so as to be deployed and retreated by drive of the third drive unit 25. Forward and backward rotation actions will be described in detail below.

The first embodiment is characterized in that at the time of retreating the second armrest 24 to the retreated position 24b, the second armrest 24 is moved by an arc trajectory curved as shown by an arrow 26 in such a manner that the second armrest 24 is not brought into contact with an elbow and a shoulder of the passenger of the wheelchair 20. This trajectory is a route in which a leading end of the second armrest 24 is moved rearward while being rotated so as to go away from the other side part of the first support portion 22b and go toward the retreated position 24b on a back surface of the first support portion 22b. It should be noted that at the time of deploying the second armrest 24 to the deployed position 24a, reverse movement to the above description is performed. That is, at the time of deployment and retreating, the second armrest 24 in the first embodiment is moved in the direction of going away from the side part of the first support portion 22b and then moved in the direction of coming close to the back surface of the first support portion 22b, so as to be moved to draw a large arc. Such movement of the second armrest 24 is particularly effective in the wheelchair 20 to be combined with the bed base portion 30 as in the first embodiment. This is because the passenger seated on the second seat portion 22 of the wheelchair 20 as in the first embodiment is highly possibly seated close to the side of the bed base portion 30, and particularly highly possibly brought into contact with the second armrest 24 on the side of the bed base portion 30.

In the first embodiment, the second armrest 24 is retreated to the opposite side of the bed base portion 30 behind the first support portion 22b. Thus, a first rotation axis 27 serving as the rotation center of the second armrest 24 is arranged on an imaginary plane 28 serving as a plane perpendicular to the back bottom support surface 22a and parallel to the front and rear direction of the second seat portion 22 (front and rear direction of the wheelchair 20). Altogether, in the first embodiment, the second armrest 24 is arranged and inclined with respect to the back bottom support surface 22a by a predetermined angle (for example, 10° or more and 170° or less in the first embodiment, 45° as one specific example). By arranging the first rotation axis 27 on the imaginary plane 28, the second armrest 24 of the first embodiment is moved and retreated while a posture of an upper surface of the second armrest 24 (surface on which an arm of the passenger is placed, the arm mount surface 24a-1) is changed in the vertical direction as a retreating action progresses. By moving the second armrest 24 in such a way, even in a case where the retreating action of the second armrest 24 is performed while the passenger places his/her arm on the arm mount surface 24a-1, the arm of the passenger slips off onto a knee or a thigh from the arm mount surface 24a-1. Therefore, upon the retreating action of the second armrest 24, the arm of the passenger is less possibly nipped between the second armrest 24 and another member, so that safety is obtained. Further, by the retreating action of the second armrest 24, the passenger is not required to perform not only an action of making the shoulder avoid but also an action of lowering the arm from the arm mount surface 24a-1 of the second armrest 24. By arranging the first rotation axis 27 on the imaginary plane 28, the third drive unit 25 can be formed by a single-axis motor. Thus, a configuration that the second armrest 24 is retreated to the back surface of the first support portion 22b can be realized as a simple configuration.

It should be noted that at the deployed position 24a protruding forward, the arm mount surface 24a-1 of the second armrest 24 is arranged along the horizontal direction or placed at an inclination angle of about 90° with respect to the back bottom support surface 22a. Meanwhile, at the retreated position 24b moved to the back surface side, the second armrest 24 does not protrude toward the side from the first support portion 22b but is placed on a back surface of the back bottom support surface 22a.

The trajectory of the arrow 26 will be described with using FIGS. 2 and 3A to 3C. FIG. 2 is a plan view of the bed 40 showing an action of the second armrest 24 in the first embodiment.

FIG. 3A is a perspective view showing the wheelchair 20 in a state where the second armrest 24 is placed at the deployed position 24a. FIG. 3B is a perspective view showing the wheelchair 20 in a state where the second armrest 24 is placed at the retreated position 24b.

As shown in FIG. 3A, the second operating unit 41 configured of a joystick, buttons, or the like is arranged in a leading end of the first armrest 23 placed on the opposite side of the bed base portion 30 at the time of combination. In the wheelchair 20, by control of the second control unit 36 based on the operation of the second operating unit 41, a traveling action, a posture change action of changing a posture of the second seat portion 22, and actions of retreating and deploying the second armrest 24 can be performed. The second control unit 36 is arranged in the carriage portion 21 or the like. In the first embodiment, as shown in FIG. 3B, the second armrest 24 retreated to the retreated position 24b is placed in such a manner that the arm mount surface 24a-1 of the second armrest 24 is parallel to the back bottom support surface 22a on the back surface of the back bottom support surface 22a.

A rotation action of the second armrest 24 between the deployed position 24a and the retreated position 24b is set to be performed in a state where the wheelchair 20 is in a tilt posture in the following description. However, as shown in FIG. 3B, this rotation action can also be performed when the wheelchair 20 is in a chair posture. For example, when the passenger moves to a bathroom or the like by the wheelchair 20 and gets off the wheelchair 20 in the lateral direction, based on the operation of the second operating unit 41, the rotation action of the second armrest 24 is performed, so that the passenger can easily get on and off.

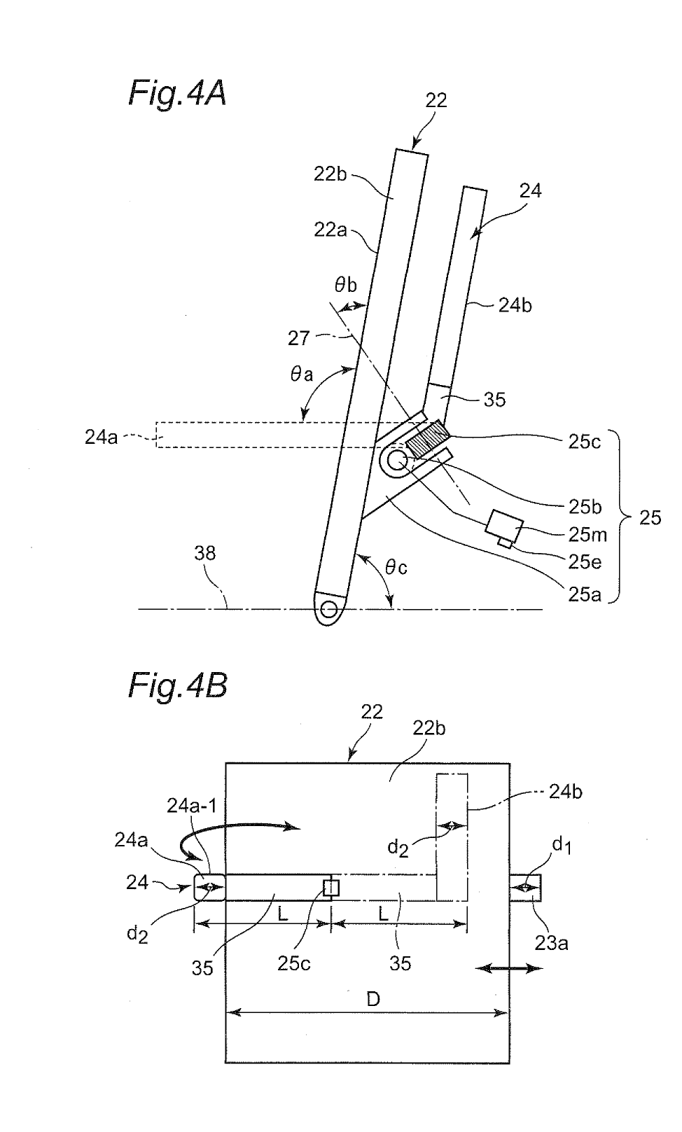

Successively, with using FIG. 4A, a structure of the third drive unit 25 of the wheelchair 20 of the first embodiment will be described. FIG. 4A is a schematic sectional view of a vicinity part of the back bottom support surface 22a and the third drive unit 25 on the imaginary plane 28.

As shown in FIG. 4A, the third drive unit 25 of the first embodiment includes a housing 25a, a worm gear 25b, a worm wheel 25c, and a motor 25m. The housing 25a is fixed to the back surface of the first support portion 22b. The worm gear 25b is rotatably supported by the housing 25a, and coupled to a rotation shaft of the motor 25m fixed to the housing 25a. The worm wheel 25c is rotatably supported by the housing 25a and coupled to the worm gear 25b, and converts forward and backward rotation of the motor 25m into forward and backward rotation about the first rotation axis 27 via the worm gear 25b and the worm wheel 25c. By fixing the worm wheel 25c to the L shape portion 35 of the second armrest 24, the second armrest 24 performs the rotation action about the first rotation axis 27.

An angle between the second armrest 24 at the deployed position 24a and the back bottom support surface 22a is θa, an angle between the first rotation axis 27 and the back bottom support surface 22a is θb, and an angle made by the back bottom support surface 22a with the horizontal direction 38 is θc. The larger the angle θb is, the more outward (going away from the wheelchair 20) a trajectory of the second armrest 24 is expanded. Thus, the shoulder of the passenger can be more reliably avoided. However, since the trajectory of the second armrest 24 is expanded outward, the arm of the passenger slips off to a position away from a body. Therefore, in order to reduce a burden of the passenger, there is a need for setting a proper value as a value of the angle θb. In the first embodiment, θb=θa/2 is set so that the trajectory of the second armrest 24 reliably avoids the shoulder of the passenger, and in a case where the arm of the passenger slips off, the arm slips off near the body of the passenger.

It should be noted that in the first embodiment, θa+θc=180° is set so that the arm mount surface 24a-1 is horizontal at the deployed position 24a. However, the angle of θa is desirably changed in accordance with the passenger, for example θa=90° is set or the like in a case where a passenger having a narrow elbow movable range due to muscle contracture or the like is seated.

Successively, with using FIG. 4B, a length of the L shape portion 35 will be described. The first armrest 23 is fixed to the first support portion 22b at a fixing portion 23a slidable in the lateral direction in the figure. FIG. 4B shows a state where the fixing portion 23a and the first armrest 23 accommodated on the back side of the first support portion 22b are pulled out. In a case where a width of this first armrest 23 is d1, a width of the second armrest 24 is d2, and a width of the first support portion 22b is D, a length L of the L shape portion 35 from a L shape bending portion of the second armrest 24 (inner end of the arm mount surface 24a-1) to the first rotation axis 27 (rotation center of the worm wheel 25c) is required to be L={D+(d1−d2)}/2 or less in the first embodiment. That is, in the first embodiment, the first rotation axis 27 is placed offset from the center in the width direction of the second seat portion 22. This is a configuration that the second armrest 24 can be reliably rotated via the L shape portion 35 without contact with the first armrest 23, and the second armrest 24 does not protrude from the first support portion 22b in the lateral direction at the retreated position 24b.

It should be noted that in a case where there is no need for accommodating the fixing portion 23a of the first armrest 23 on the back of the first support portion 22b, the length L may be L=(D+d1)/2 or less.

By combining the wheelchair 20 described above with the bed base portion 30, the second seat portion 22 and the first seat portions 31 are arranged on the same plane, so as to be utilized as the bed 40. In the bed 40 of the first embodiment, by separating a part thereof and utilizing the part as the wheelchair 20, an action (transferring action) of moving a care-receiver (passenger) from the bed 40 to the wheelchair 20 can be simply performed.

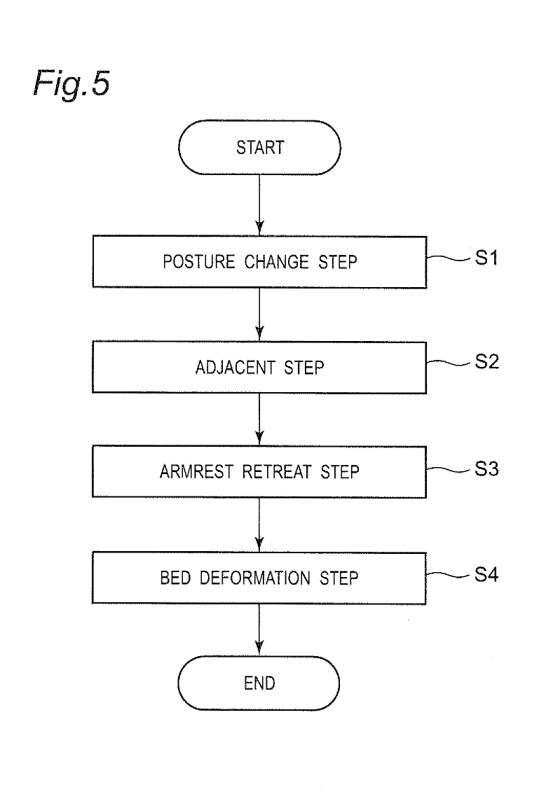

With using FIGS. 5 to 7B, combination actions of combining the wheelchair 20 of the first embodiment with the bed base portion 30 to form the bed 40 will be described. The series of actions are performed by the control of the second control unit 36 based on the operation of the second operating unit 41.

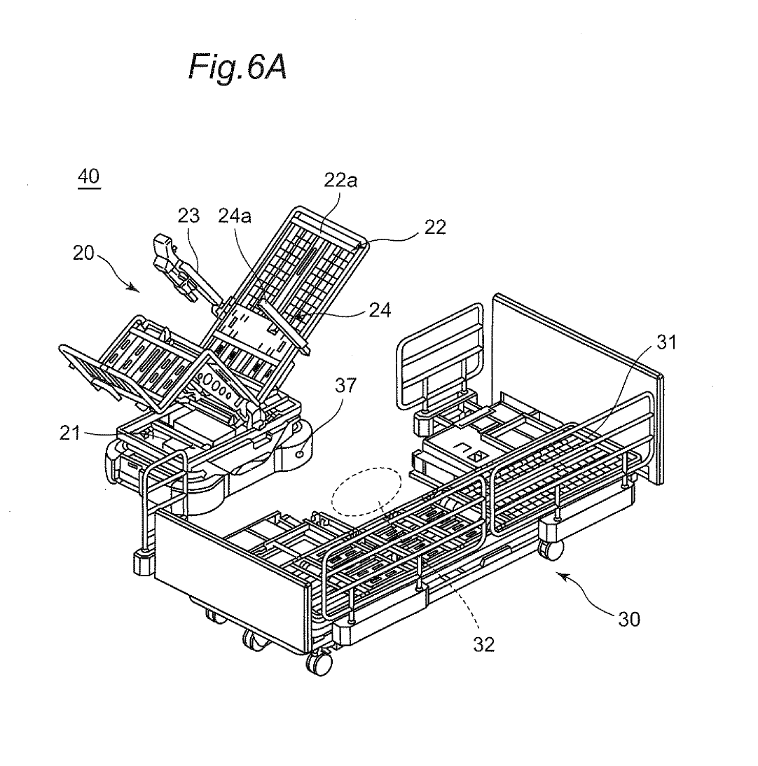

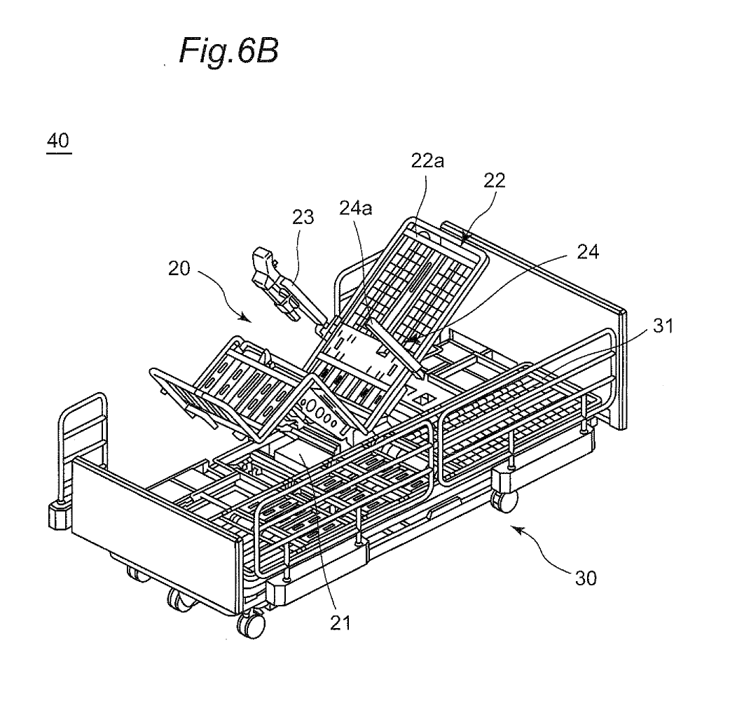

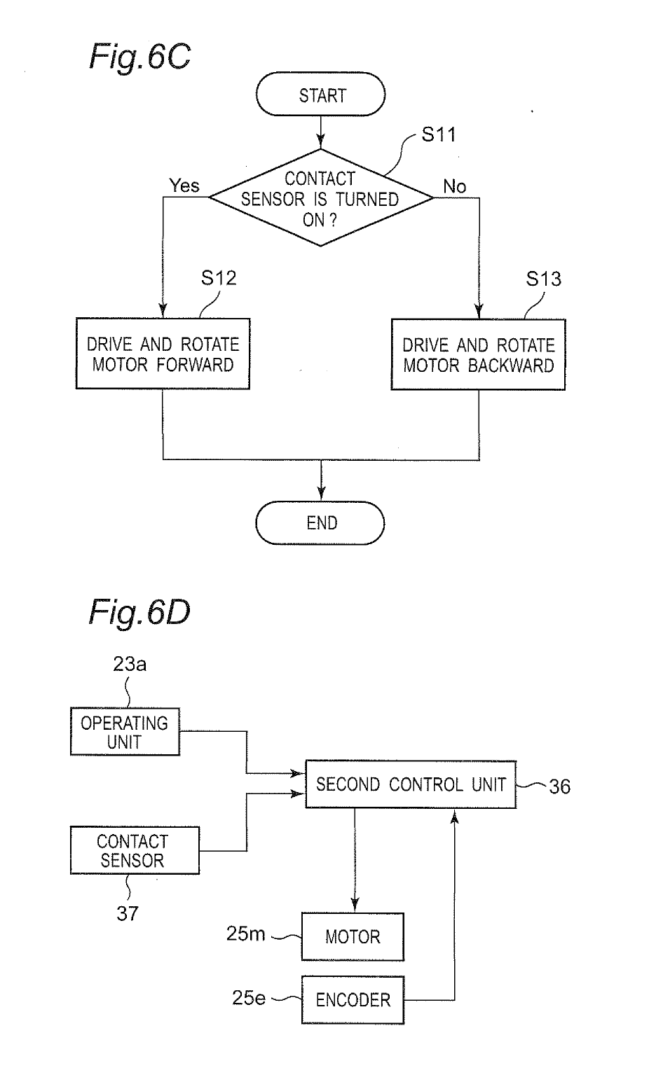

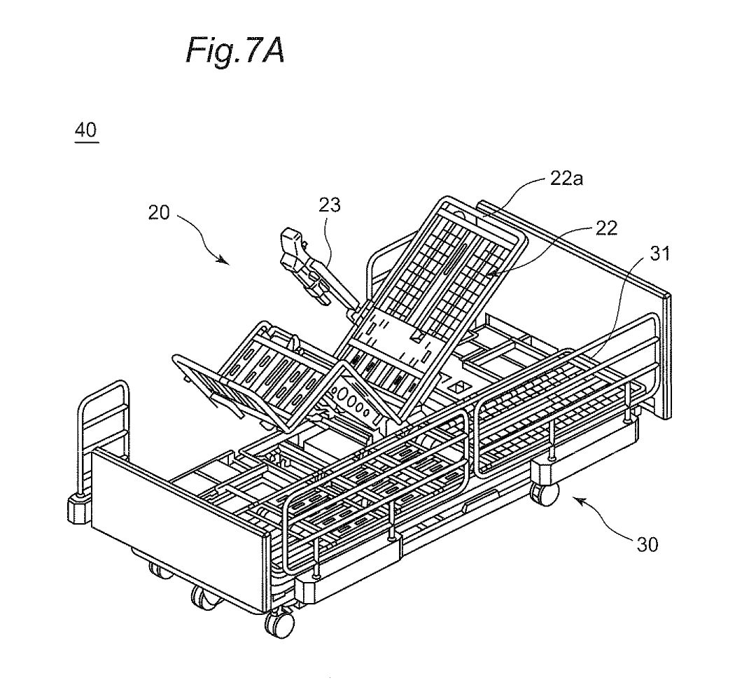

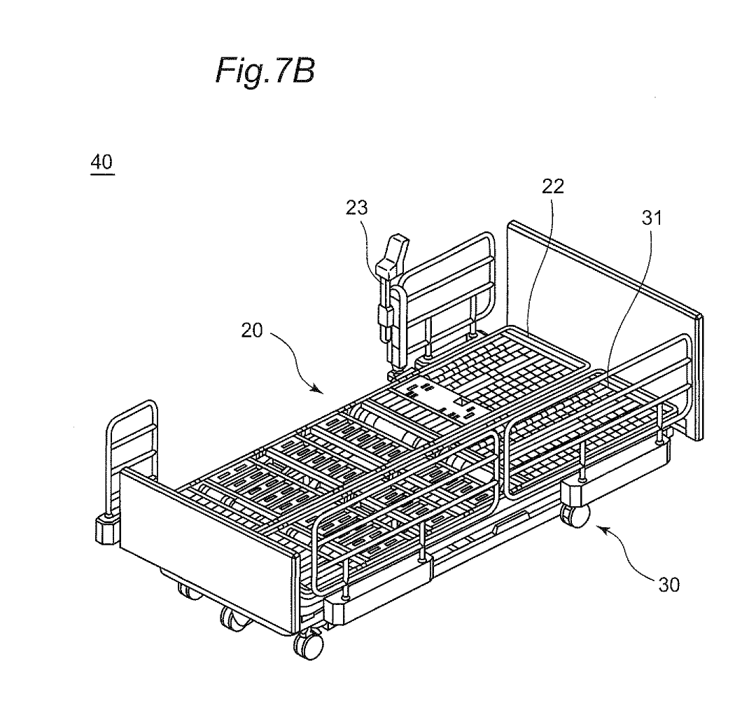

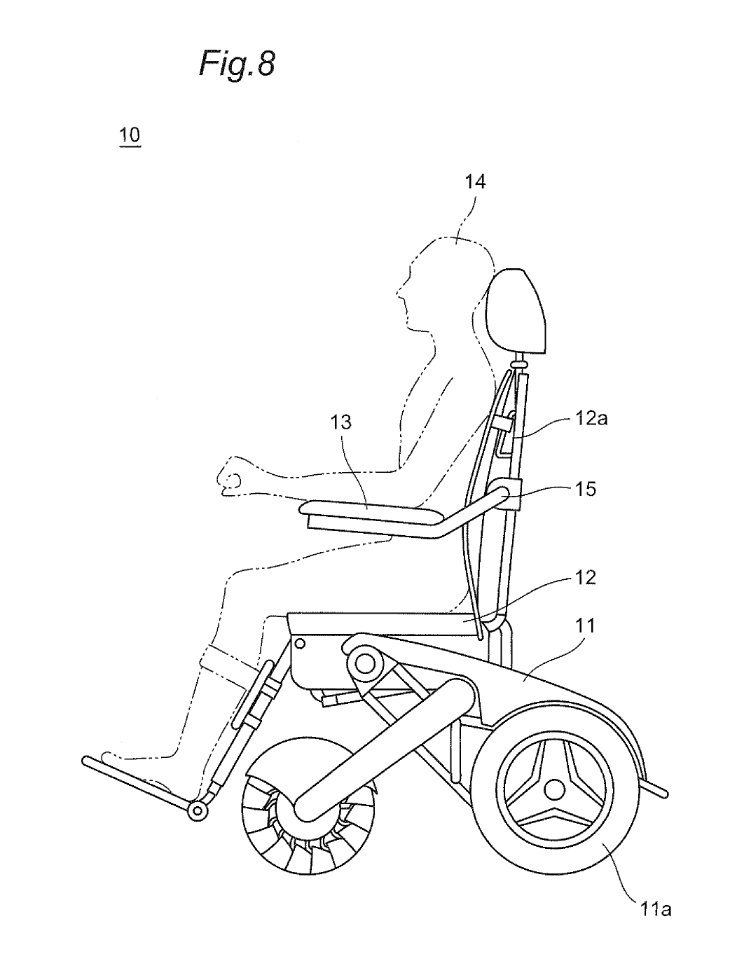

FIG. 5 is a flowchart showing the combination actions of combining the wheelchair 20 with the bed base portion 30. FIG. 6A is a perspective view of the wheelchair 20 and the bed base portion 30 in a state where a posture change step is completed. FIG. 6B is a perspective view of the wheelchair 20 and the bed base portion 30 in a state where an adjacent step is completed. FIG. 7A is a perspective view of the wheelchair 20 and the bed base portion 30 in a state where an armrest retreating step is completed. FIG. 7B is a perspective view of the wheelchair 20 and the bed base portion 30 in a state where a bed deformation step is completed. It should be noted that in the figures, cushion members such as a mat originally provided in the bed and the wheelchair are omitted for clarifying the structure.

At the time of combining the wheelchair 20 with the bed base portion 30, the passenger operates the second operating unit 41 to provide a combination instruction to the bed base portion 30. When the combination instruction is provided from the passenger, the combination actions of the wheelchair 20 and the bed base portion 30 are performed by the control of the second control unit 36 based on the flowchart shown in FIG. 5.

Firstly, in a posture change step S1, the second control unit 36 of the wheelchair 20 changes the posture of the second seat portion 22 into the tilt posture as shown in FIG. 6A. The tilt posture is a posture in which the second seat portion is inclined rearward by about 30° to 45° while being in the chair posture.

Successively, in an adjacent step S2, by moving the wheelchair 20 in the tilt posture into a recess 32 of the bed base portion 30 by the control of the second control unit 36, the wheelchair 20 is placed to be adjacent to the bed base portion 30 as shown in FIG. 6B. Completion of the adjacent step S2 is detected by a contact sensor 37 (refer to FIG. 6A) serving as one example of a combination detecting unit. By bringing the contact sensor 37 provided in the wheelchair 20 on the side of the bed base portion 30 into contact with the bed base portion 30 and turning the contact sensor 37 on, the completion of the adjacent step S2 is detected, and the second control unit 36 outputs a detection signal (Step S11 of FIG. 6C). In a case where the detection signal is outputted (Yes in Step S11), the motor 25m is driven by the second control unit 36, and the second armrest 24 is rotated from the deployed position 24a to the retreated position 24b (Step S12). On the contrary, when the wheelchair 20 is brought away from the bed base portion 30, by bringing the contact sensor 37 away from the bed base portion 30 and turning the contact sensor 37 off, a signal indicating detection cancellation is outputted to the second control unit 36 or the detection signal is not outputted to the second control unit 36 (No in Step S11). In this case, the motor 25m is reversely driven by the second control unit 36, and the second armrest 24 is rotated from the retreated position 24b to the deployed position 24a (refer to Step S13). An encoder 25e is provided in the motor 25m. By detecting a rotation angle of the rotation shaft of the motor 25m by the encoder 25e, the second armrest 24 is respectively positioned at the retreated position 24b and the deployed position 24a. With such a configuration, in conjunction with an approaching action and a separation action of the wheelchair 20 with respect to the bed base portion 30, the rotation action of the second armrest 24 (for example, an armrest retreating step S3) can be automatically performed.

Successively, in the armrest retreating step S3, a retreating action of the second armrest 24 is performed. Specifically, in the armrest retreating step S3, as described with using FIGS. 2 to 3C, the motor 25m is driven and rotated by the control of the second control unit 36 based on the operation of the second operating unit 41, and the second armrest 24 placed at the deployed position 24a is rotated by about 180° and retreated to the retreated position 24b on the back surface of the back bottom support surface 22a and brought into a state shown in FIG. 7A. In such a way, when the second armrest 24 is moved from the deployed position 24a to the retreated position 24b, by performing the rotation action of the second armrest 24 as in the first embodiment by the wheelchair 20 in the tilt posture, the second armrest 24 can be smoothly moved without contact with other members such as the bed base portion 30. Further, the configuration of the present embodiment is a configuration that the second armrest 24 can be reliably retreated with a simple structure having only one drive unit. Therefore, by using only one drive unit, the structure for retreating the second armrest 24 can be simplified as a whole.

Finally, in a bed deformation step S4, by changing the posture of the second seat portion 22 into a flat posture and then raising the first seat portions 31 of the bed base portion 30, the second seat portion 22 and the first seat portions 31 are brought into the same plane state as shown in FIG. 7B. As a result, the state is transitioned into a bed state in which the portions can be used as the bed 40. The flat posture is a posture in which all the surfaces forming the second seat portion 22 are in the substantially one plane state. The first armrest 23 is arranged at a position shown in FIG. 7B in such a manner that the second operating unit 41 can be operated in a state of the bed 40.

It should be noted that a lifting mechanism (not shown) of the bed base portion 30 can lift the second seat portion 22 and the first seat portions 31 at the same time in the bed 40 formed by combining the wheelchair 20 and the bed base portion 30, by control of the first control unit 39 based on the operation of the first operating unit 44. Similarly, the first drive unit 42 of the bed base portion 30 can integrally change postures of the second seat portion 22 and the first seat portions 31 in the bed 40 formed by combining the wheelchair 20 and the bed base portion 30, by the control of the first control unit 39 based on the operation of the first operating unit 44.

It should be noted that in the first embodiment, the second armrest 24 is an electrically driven type tube deployed and retreated by the motor 25m. With such a configuration, in the bed 40, the combination and separation actions of the wheelchair 20 and the bed base portion 30 can be realized only by the operation of the second operating unit 41.

According to the first embodiment, the wheelchair and the bed to be combined with the wheelchair, with each of which there is no need for making the elbow and the shoulder of the passenger avoid at the time of retreating and the time of deploying can be provided.

As described above, in the wheelchair 20 of the first embodiment, when the second armrest 24 is rotated from the deployed position 24a to the retreated position 24b, a base end of the arm mount surface 24a-1 of the second armrest 24 starts movement toward the left upper side which is the obliquely rear side of the passenger, and the arm mount surface 24a-1 is rotated so as to turn around the outer side of the shoulder of the passenger. Therefore, the arm mounted on the arm mount surface 24a-1 naturally drops off to the front side. After that, by continuously rotating the second armrest 24, the arm mount surface 24a-1 is rotated to the retreated position 24b which is a position parallel to the back bottom support surface 22a and the stopped on the back surface side of the first support portion 22b. Therefore, the second armrest 24 does not protrude outward from the first support portion 22b and not collide with the first armrest 23 on the other side.

The second armrest 24 is rotated to come around to the back surface side of the first support portion 22b on the rear side of the passenger. Thus, the passenger can smoothly perform the actions without feeling danger.

In the first embodiment, the second armrest 24 is placed at the deployed position 24a until the wheelchair 20 is brought into the tilt posture. Thus, the passenger of the wheelchair 20 can be prevented from dropping off to the bed base portion 30 or the like from the wheelchair 20 in the middle of combination.

It should be noted that the present invention is not limited to the above embodiment but can be implemented in various other modes. For example, although the second armrest 24 is an electrically driven type to be deployed and retreated by the motor 25m in the first embodiment, the second armrest may be a manually operated type to be deployed and retreated by human hands.

By properly combining the arbitrary embodiment (s) or modification(s) of the aforementioned various embodiments and modifications, the effects possessed by the embodiment(s) or modification(s) can be produced.

Although the present invention has been fully described in connection with the embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

### INDUSTRIAL APPLICABILITY

In the wheelchair of the present invention and the bed to be combined with the same, an action of the passenger to make the shoulder avoid is not required at the time of retreating the armrest so as to reduce the burden of the passenger. Thus, the wheelchair and the bed are useful particularly in the nursing care or medical field.

1-14. (canceled)

15. A wheelchair comprising:
a first seat portion that at least has a first support portion having a back bottom support surface on a surface;
first and second armrests; and
a third drive unit that forward and backward rotates the second armrest about a first rotation axis, to move the second armrest between a deployed position and a retreated position placed behind the first support portion,
wherein the first rotation axis is arranged on a plane perpendicular to the back bottom support surface of the first seat portion and parallel to a front and rear direction of the first seat portion.

16. The wheelchair according to claim 15, wherein
an angle between the back bottom support surface of the first seat portion and the first rotation axis is 10° or more and 170° or less.

17. The wheelchair according to claim 15, wherein
one end side of the second armrest connected to the third drive unit is configured of an L shape member.

18. The wheelchair according to claim 16, wherein
one end side of the second armrest connected to the third drive unit is configured of an L shape member.

19. The wheelchair according to claim 17, wherein
in a case where a width of the first armrest is d1, a width of the second armrest is d2, and a width of the first support portion is D, a length L from a L-shaped bending portion of the L shape member to the third drive unit is L={D+(d1−d2)}/2 or less.

20. The wheelchair according to claim 18, wherein
in a case where a width of the first armrest is d1, a width of the second armrest is d2, and a width of the first support portion is D, a length L from a L-shaped bending portion of the L shape member to the third drive unit is L={D+(d1−d2)}/2 or less.

21. The wheelchair according to claim 15, wherein
the first rotation axis is arranged at a position offset from a center in a width direction of the first seat portion.

22. The wheelchair according to claim 16, wherein
the first rotation axis is arranged at a position offset from a center in a width direction of the first seat portion.

23. The wheelchair according to claim 17, wherein
the first rotation axis is arranged at a position offset from a center in a width direction of the first seat portion.

24. The wheelchair according to claim 19, wherein
the first rotation axis is arranged at a position offset from a center in a width direction of the first seat portion.

25. The wheelchair according to claim 19, wherein
the first rotation axis is arranged at a position offset from a center in a width direction of the first seat portion.

26. The wheelchair according to claim 15, wherein
when being rotated about the first rotation axis, the second armrest is moved in a direction of going away from a side part of the first support portion and then moved in a direction of coming close to a back surface of the first back bottom support portion.

27. The wheelchair according to claim 16, wherein
when being rotated about the first rotation axis, the second armrest is moved in a direction of going away from a side part of the first support portion and then moved in a direction of coming close to a back surface of the first back bottom support portion.

28. The wheelchair according to claim 17, wherein
when being rotated about the first rotation axis, the second armrest is moved in a direction of going away from a side part of the first support portion and then moved in a direction of coming close to a back surface of the first back bottom support portion.

29. A bed comprising:
the wheelchair according to claim 15; and
a bed base portion to be combined with the wheelchair to form the bed.

30. A bed comprising:
the wheelchair according to claim 16; and
a bed base portion to be combined with the wheelchair to form the bed.

31. The bed according to claim 29, wherein
the second armrest is an armrest on a side of the bed base portion of the first support portion.

32. The bed according to claim 31, wherein
the retreated position is placed on an opposite side of the bed base portion on a back surface side of the first support portion.

33. The bed according to claim 29, further comprising:
a combination detecting unit that detects combination between the wheelchair and the bed base portion; and
a second control unit that moves the second armrest of the wheelchair in which a posture of the first seat portion is in a tilt posture from the deployed position to the retreated position when the combination detecting unit detects the combination.

34. The bed according to claim 29, further comprising:
a first operating unit that instructs the first control unit that controls an action of the bed on an operation; and
a second operating unit that instructs the second control unit that controls an action of the wheelchair and a third control unit that controls the third drive unit on an operation.
